(19) United States
(12) Patent Application Publication
(10) Pub. No.: US 2008/0005325 A1
(43) Pub. Date: Jan. 3, 2008

(54) USER COMMUNICATION RESTRICTIONS

(75) Inventors: Roger H. Wynn, Redmond, WA (US); Timothy A. Gill, Seattle, WA (US); Peter M. Wiest, Issaquah, WA (US); David S. Bennett, Issaquah, WA (US); Stan D. Pennington, Newcastle, WA (US); Aaron Culbreth, Bellevue, WA (US)

Correspondence Address: VIERRA MAGEN/MICROSOFT CORPORATION, 575 MARKET STREET, SUITE 2500, SAN FRANCISCO, CA, 94105, US

(73) Assignee: MICROSOFT CORPORATION, Redmond, WA (US)

(21) Appl. No.: 11/427,193

(22) Filed: Jun. 28, 2006

(51) Int. Cl. G06F 15/173

(52) U.S. Cl. 709/225

(57) ABSTRACT

Communications provided via e-mail, instant messaging, chat, and web-based telephony applications, are monitored and restricted at a computer host. In one approach, messages from unknown or unsafe senders are intercepted and stored in a location inaccessible to all but an authorized person, until they can be reviewed by the authorized person, such as a parent. Via a user interface, the authorized user can review the messages at a later time to determine if the intended recipient, such as a child, should be able to access them. Once access is authorized, the stored messages are retrieved and provided to the recipient. In another aspect, a shared allow/block contact list identifies a user having different user names from one or more service providers. The contact list can integrate users from different services and communication modes. In another aspect, notification of monitoring is provided in the monitored messages or in newly generated messages.

### BACKGROUND

With the growth of the Internet, the user's ability to communicate with others and obtain information has never been greater. However, in many cases, this capability must be limited for the protection of the user or for other reasons. For example, it may be desirable to restrict and/or record a user's activity at the computer to allow a parent to control a child's contact with the outside world, such as to avoid exposing the child to inappropriate content, to prevent on-line predators from contacting the child, and to otherwise control the child's use of the computer for disciplinary reasons. Similarly, it may be desirable for an employer to control an employee's ability to communicate via computer to ensure corporate security, and for legal and fiscal compliance reasons.

Monitoring may be desired in other situations as well. However, restricting a user's communications in a meaningful way presents various issues due to the use of different communication modes such as e-mail, instants messaging, gaming and other web chat and telephony, for instance, and corresponding different applications. Moreover, applications of different service providers can be used by different users for a given communication mode. Communications should be controlled in a consistent way across the different applications.

A solution is needed for monitoring and restricting user communications which addresses the above and other issues.

### SUMMARY

Various techniques are provided for monitoring and restricting computer network-based communications which are received and/or sent by a user.

In one aspect, a computer-implemented method for restricting communications at a computer host includes monitoring messages, such as e-mail, instant messaging, gaming or other web chat, and web-based telephony messages, which are sent to the computer host via a network and intended for receipt by a user via an application at the computer host. A determination is made as to whether the messages meet a restriction condition. For example, a restriction condition may restrict the time or date in which a message can be received. As an example, a child may be prohibited from receiving any messages during a period on weeknights when homework is scheduled. A restriction may also be imposed so that messages from a particular sender, such as an unknown or blocked sender, cannot be received at all. Or, messages may be restricted by type, for example, so that an instant message is not allowed but an e-mail message is allowed. If a message meets the restriction condition, that is, it is restricted in some way, the message can be intercepted before it is made accessible to the user via the application, and the message can be stored so that it is inaccessible to the user. For example, the message can be stored on the computer host under password protection. Optionally, the message can be encrypted. The stored message can subsequently be made accessible to the user via the application when an appropriate authorization is provided, such as when a parent, administrator or other authorized user enters a password.

In one option, the user is informed of the fact that the message has been received but made inaccessible to the user. For example, a new message can be provided to the user which includes the restricted message as an encrypted or other access-restricted attachment. The user can select the attachment or other indicia to launch a process for requesting that an authorized user provide the authorization. A user interface can be provided which allows an authorized user to access the stored message and to enter a command for providing the authorization, if the authorized user deems the message to be appropriate for the intended recipient. In another option, the user is not informed that the message has been received and made inaccessible. As before, the authorized user can review the message at a convenient time and, if desired, enter a command for providing the authorization.

In another aspect, a computer-implemented method for restricting communications at a computer host includes monitoring messages which are sent to the computer host, where the messages include an identifier of the sender. For example, for an instant message, the identifier can be a screen name of the sender. A unique identifier which is associated with the identifier in the message is determined. The unique identifier can be an e-mail address, alpha/numeric string or any other data which uniquely identifies the particular user. Information can be obtained from different service providers, such as e-mail and instant messaging service providers, which links the unique identifier with different screen names or other names of a user. Thus, a user can be identified even if he or she uses different screen names and service providers. Access to the message by the second user is controlled based on a block or allow status which is associated with the unique identifier. For example, the unique identifiers can be used to provide a list of restricted users, for which messages cannot be received or sent, or a list of allowed users, for which messages can be received or sent. Furthermore, restrictions can be imposed on the type of messages received, the date or time messages can be received, and so forth. These restrictions can be imposed on each user, as identified by the unique identifier, or on each user name.

In yet another aspect, one or more users whose messages are being monitored are informed of the monitoring using the same application over which the messages are provided, such as to meet legal and ethical requirements. In this aspect, when a monitored message is received, the sender and/or recipient is notified of the monitoring via the communications application used to receive and/or send the message. For example, this can be achieved by modifying the monitored message to include a notification, such as by providing a header or footer message on an e-mail or instant messaging message, or by providing an audible message in a telephony message. Or, a new message which includes a notification can be generated and provided to the sender and/or recipient via the communications application. The notification can be provided when the communication begins, when a new user joins an ongoing communication, and/or at specified time intervals.

This summary is provided to introduce a selection of concepts in a simplified form that are further described below in the description. This summary is not intended to identify key features or essential features of the claimed subject matter, nor is it intended to be used to limit the scope of the claimed subject matter.

### BRIEF DESCRIPTION OF THE DRAWINGS

FIG. 1 illustrates an overview of a network topology in which communications of a monitored user are restricted.

FIG. 2 illustrates a process for intercepting restricted messages.

FIG. 3 illustrates a process for authorizing access to restricted messages.

FIG. 4 illustrates a user interface for configuring user restrictions.

FIG. 5 illustrates a user interface for setting up user restrictions for instant messaging.

FIG. 6 illustrates a user interface for setting up user restrictions for e-mail.

FIG. 7 illustrates an inbox of an e-mail application of a monitored user showing a first format of a blocked message.

FIG. 8 illustrates an inbox of an e-mail application of a monitored user showing a second format of a blocked message.

FIG. 9 illustrates an e-mail message with an encrypted attachment of a blocked message.

FIG. 10 illustrates an activity report for e-mails of a monitored user.

FIG. 11 illustrates a blocked e-mail which is read via an activity report.

FIG. 12 illustrates an inbox of an e-mail application of a monitored user showing a previously blocked e-mail for which access was authorized.

FIG. 13a illustrates a process for obtaining contact information for a shared allow/block contact list.

FIG. 13b illustrates a process for determining an allow or block status of a contact in a shared allow/block contact list.

FIG. 14a illustrates a user interface for configuring a shared allow/block contact list.

FIG. 14b illustrates a tree view user interface for a shared allow/block contact list, arranged by user and communication type.

FIG. 14c illustrates a tree view user interface for a shared allow/block contact list, arranged by user.

FIG. 15a illustrates a process for notifying e-mail users of monitoring.

FIG. 15b illustrates another process for notifying e-mail users of monitoring.

FIG. 15c illustrates a process for notifying chat session users of monitoring.

FIG. 15d illustrates a process for notifying telephony session users of monitoring.

FIG. 16 illustrates an instant message which has been modified to include a notification of monitoring.

FIG. 17 illustrates a newly generated instant message which includes a notification of monitoring.

FIG. 18 illustrates an e-mail message which has been modified to include a notification of monitoring.

FIG. 19 illustrates a newly generated e-mail message which includes a notification of monitoring for a recipient.

FIG. 20 illustrates a newly generated e-mail message which includes a notification of monitoring for a sender.

FIG. 21 illustrates a communications restriction architecture.

FIG. 22 is a block diagram of computer hardware suitable for implementing embodiments of the invention.

### DETAILED DESCRIPTION

Various techniques are provided for restricting computer network-based communications such as e-mail, instant messaging, game or other web chat, and web-based telephony messages, which are received and/or sent by a user such as a child, employee, impaired person, or other person for whom such restrictions are desired. The techniques may be used as well for restricting and monitoring one's own communications such as to avoid receiving unsolicited or otherwise undesired messages.

An example implementation involves a parent who wishes to protect a child from communicating with anyone that is not approved by the parent. The parent sets up a policy by reviewing an unified list of contacts, selects the people the child is allowed to communicate with and selects an option to have allowed conversations be recorded. Later, the child engages in several communication sessions with allowed contacts via email, instant messaging (IM), game or other web chat and telephony, among others. Web chat generally involves a system that allows two or more logged-in users to set up a typed, real-time, on-line conversation across the web. The conversations are recorded, even though all the applications the child uses have not been modified to enable this functionality. The child notices that he is being monitored by an indicator on his or her screen or by other messages, and the users he or she is communicating with are notified about the monitoring, by, for instance, having an in-conversation chat message sent to all recipients that the chat is being recorded. When the child receives an e-mail from an unknown address, the child opens his inbox where the child notices a plain message with a link, and text that says the message was blocked, but the link can be selected to request permission to open the message. After selecting the link, the parent is summoned to approve the e-mail, which is subsequently decrypted and opened for the child to see. The child is happy that, although the e-mail was deleted from the e-mail server when it was received by the client, it is still available for reading locally once the parent approved it. The parent is happy to review an activity report and verify that the child's communications have been appropriate and safe. This is an example implementation only, as many other implementations are possible.

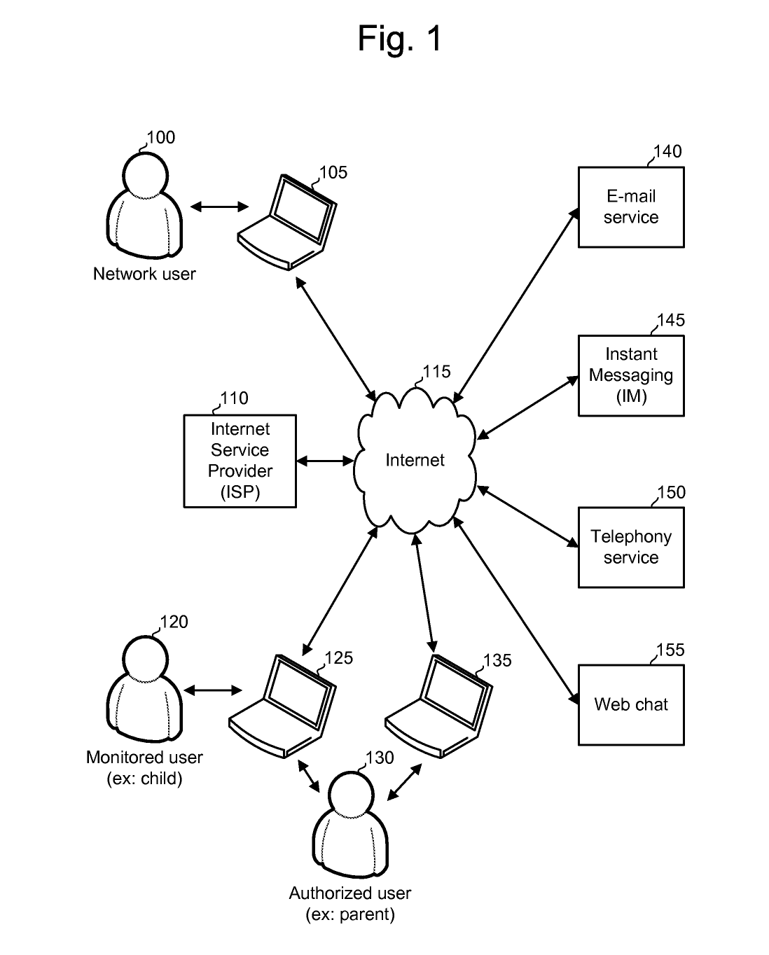

FIG. 1 illustrates an overview of a network topology in which communications of a monitored user are restricted. In the example provided, a monitored user 120, such as a child, communicates with one or more other network users using one or more communications applications, such as e-mail, instant messaging, game or other web chat, and web-based telephony applications, on a host computer 125. For example, the host computer 125 can access the Internet 115 or other wide area network (WAN) via an Internet Service Provider (ISP) 110, which in turn can access an e-mail service 140, an instant messaging (IM) service 145, a telephony service 150, a web chat service 155. The host computer 125 may also communicate via a local area network (LAN). The host computer 125 can be a workstation, laptop computer, PDA, pagers, cell phone, or other mobile device, for instance. An authorized user 130, such as a parent, may use the host computer 125 of the monitored user, or a separate host computer 135, to perform tasks such as configuring policy settings, reviewing blocked content, and deciding whether to allow the monitored user 120 to access the blocked content. A network user 100 with an associated computer host 105 represents any user who attempts to communicate with the monitored user 120, or with whom the monitored user 120 attempts to communicate.

Software for achieving the monitoring and restricting functionality can be provided on the host machines 125 and/or 135. Optionally, the host machines 125 and/or 135 communicate with a remote computing device via the network 115 to access software for achieving the monitoring and restricting functionality. Any known software techniques can be used. Note that an example is discussed in a parental controls context, but the topology is applicable to other monitoring contexts as well.

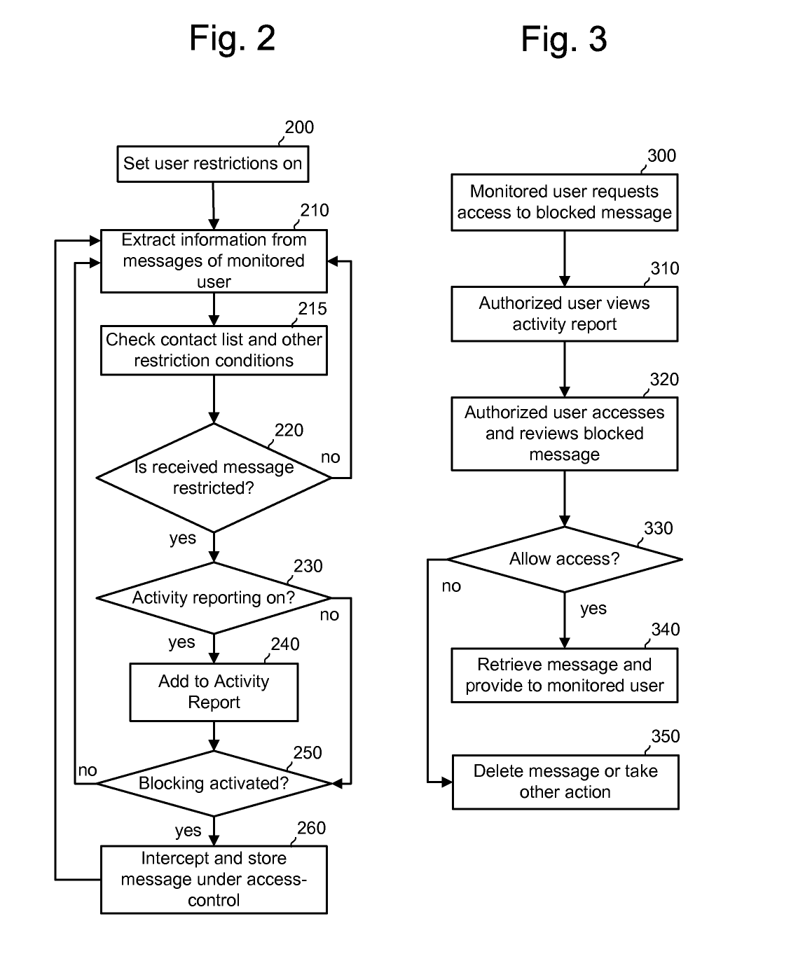

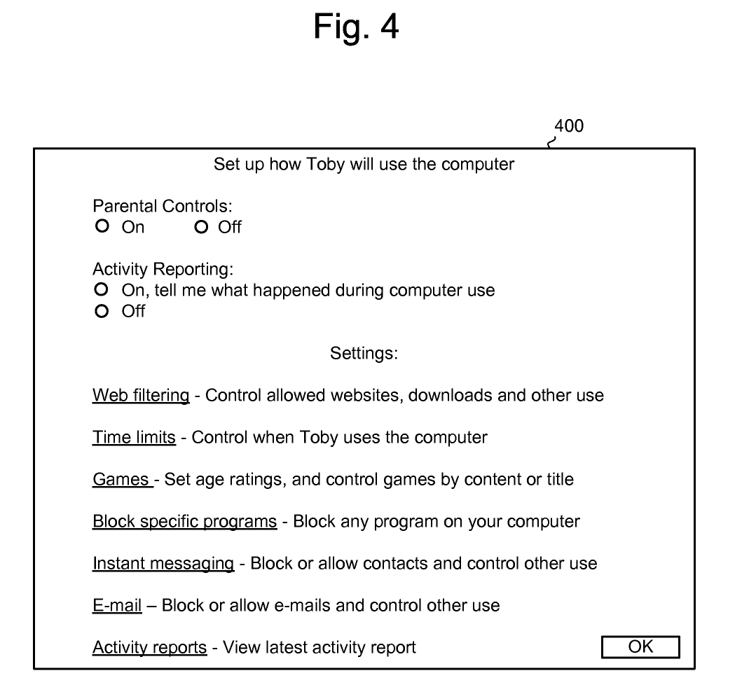

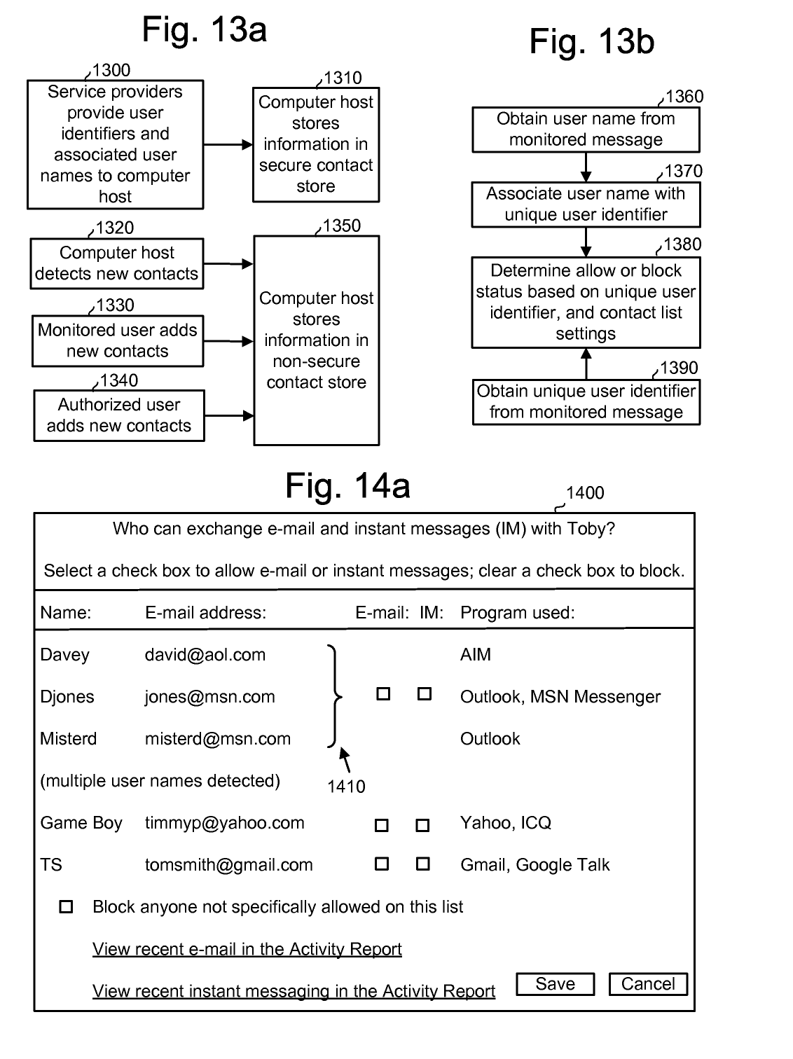

FIG. 2 illustrates a process for intercepting restricted messages. At step 200, the authorized user sets the user restrictions on. For example, referring also to the user interface 400 of FIG. 4, the authorized user may set parental controls on by selecting an appropriate on-off radio button or other widget. Voice interfaces may also be used. At step 210, information is extracted from messages of the monitored user, such as received and/or sent messages. For example, for a received message, the extracted information can include an identifier of the sender. At step 215, a contact list, such as the shared allow/block contact listed discussed further below, can be checked, based on the extracted identifier, to determine if the sender is on the contact list, and to determine the allow or block status of the sender if he or she is on the contact list. See FIG. 13b. Other restriction conditions, such as time/date restrictions can also be checked to determine if the message meets a restriction condition. Time and date information can be obtained, e.g., from a local clock and date function of the computer host, or from a received message.

At step 220, a determination is made as to whether a message meets a restriction condition. The message represents any type of communication which is received and/or sent by the computer host of the monitored user. Examples include e-mail messages, instant messaging messages, telephony messages, messaging from web-based gaming and the like. The restriction can meet various goals. For example, a time/date restriction can be imposed to prevent the monitored user from sending and/or receiving messages at certain times of the day or certain days of the week. A recipient and/or sender restriction prevents the monitored user from receiving messages from, or sending message to, a certain recipient or class of recipients. For example, a child may be prevented from communicating with a best friend during times in which the child is supposed to be doing homework or sleeping. A child may similarly be restricted from communicating with unknown users. If a message is not restricted, monitoring continues at step 210 by extracting information from additional messages of the monitored user.

At step 230, if the authorized user has configured an activity reporting feature, a record is made of the monitored user's activities on the computer host, at step 240, by adding the message to an activity report. If activity reporting is not configured, the control flow proceeds to step 250. The activity report can include a link to the message which can be selected to access the message. Referring to the user interface 400 of FIG. 4, the authorized user may set the activity reporting on by selecting an appropriate on-off radio button. At step 240, if activity reporting is on, the messages are added to the activity report. Referring also to the user interface 1000 of FIG. 10, the activity report can include information which assists the authorized user in quickly ascertaining the activities of the monitored user over a specified time period. For example, the activity report can include a listing of received and sent e-mails.

At step 250, if a blocking feature has been configured by the authorized user, the messages which have been found to be restricted are blocked so that the monitored user cannot access them. At step 260, the blocked messages are intercepted and stored under access-control, before they can be received and made available to the monitored user. In one approach, the messages are stored in an encrypted form. Note that the messages can be stored on the computer host of the monitored user, at a remote network location, and/or other location. Some e-mail servers, such as those which follow the POP3 protocol (Post Office Protocol, RFC 1939), delete messages once they have been received at the end user's host machine, in which case the blocked messages can be stored at the computer host of the monitored user, in one approach. The blocked messages can be stored anywhere, including a network location such as a web server or file server. The messages are thus blocked in a recoverable way in which they can be provided to the monitored user at a later time if their content is acceptable. The process can be transparent to the monitored user. If the blocking feature is not activated, monitoring continues at step 210.

In another aspect, passive user activity monitoring is provided. The communication traffic that is monitored, e.g., either via a network stack or through a compliant application, can be recorded securely by using a write-only store or by logging directly into a logging facility. This enables activity reporting without restrictive interference and allows review of communication history as the need arises. Furthermore, usage profiles can be obtained across communication types, service providers, and persons with whom the monitored user is communicating. For example, all communications from a particular user can be grouped. The authorized user can review the activity report and make a decision to block a user by modifying the contact list, for instance.

The passive monitoring can be used to generate statistical profiles which indicate who the monitored user is in communication with, what communication modes are being used, e.g., e-mail, chat, etc., what times/dates the communication takes place, and so forth.

FIG. 3 illustrates a process for authorizing access to restricted messages. As discussed in connection with FIG. 2, messages can be blocked to prevent the monitored user from accessing. The blocked messages can be stored in an access-protected manner. Subsequently, the authorized user can review the blocked messages to determine whether they are appropriate for the monitored user. Further, a capability can be provided which allows the monitored user to request access to the blocked message.

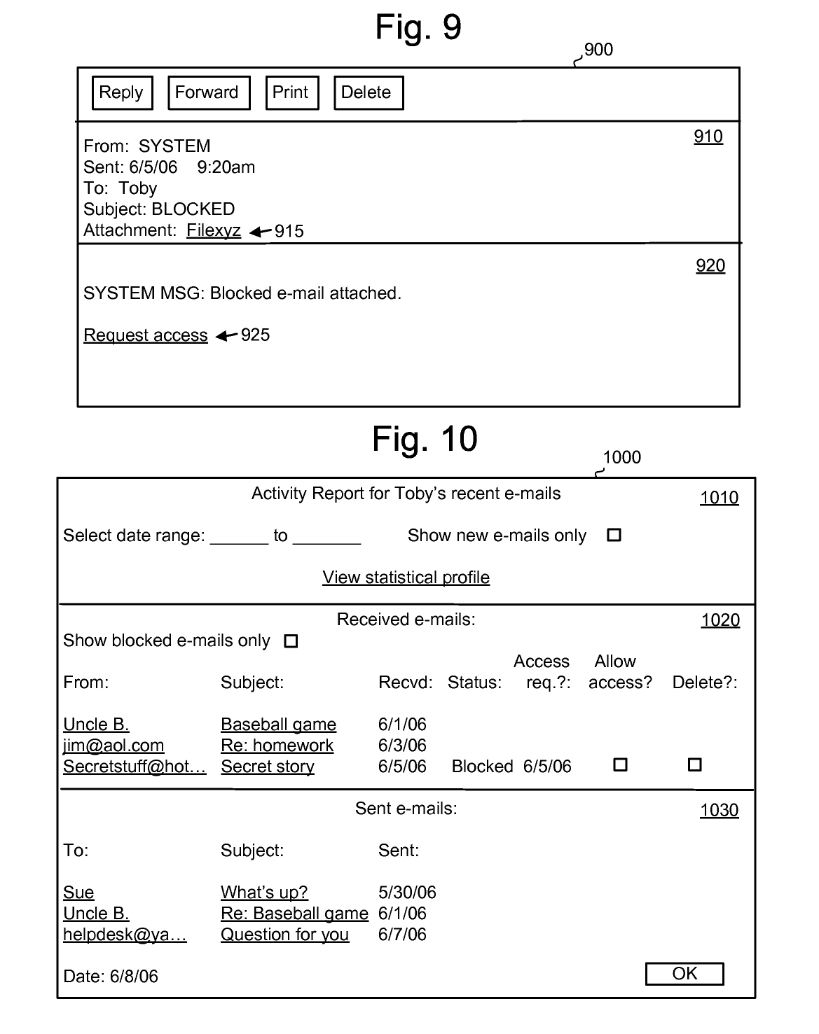

At step 300, the monitored user requests access to a blocked message. For example, this can be performed using the user interface 900 of FIG. 9 which includes a “Request access” link 925 which appears when a blocked e-mail message is opened. At step 310, the authorized user views the activity report (see the user interface 1000 of FIG. 10) to determine whether there are any blocked messages. Note that this can occur some time after the message is received and the monitored user has requested access. Generally, the authorized user can access the activity report at any desired time, regardless of whether a request for access has been made. In one approach, a message such as an e-mail message can be automatically sent to the authorized user when a request for access is made. Options for being notified that a request has been made can be configured by the authorized user. For example, the authorized user may desire to receive e-mailed requests for access after a certain time of day, e.g., in the evening, to avoid being disturbed.

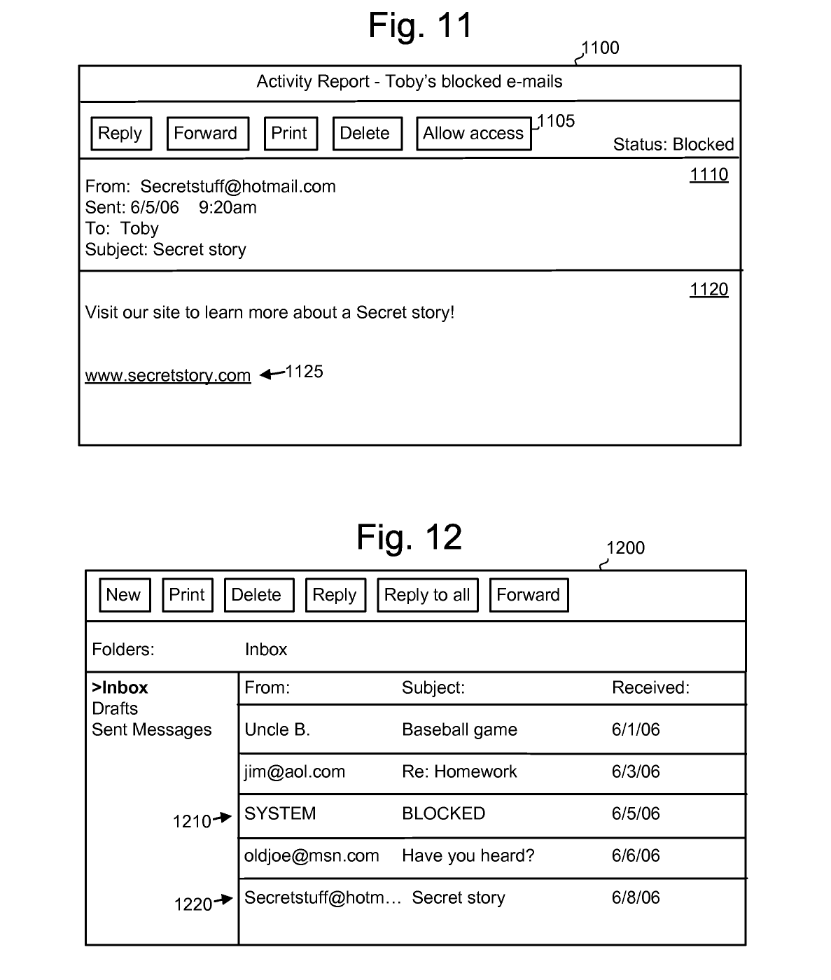

In the example of FIG. 10, the activity report is viewed on Jun. 8, 2006, three days after the blocked message was received, on Jun. 5, 2006. At step 320, the authorized user accesses and reviews the blocked messages in their original, clear form. For instance, if the messages were stored in an encrypted form, they will be decrypted and displayed. The authorized user may be prompted to enter a password to do this. The user interface 1100 of FIG. 11 provides an example of a blocked e-mail message which is reviewed by the authorized user via the activity report. The authorized user reviews the blocked message to determine whether it is appropriate for the monitored user. For example, the authorized user can review the content of the e-mail message itself as well as any links, such as the link 1125, which are in the e-mail message.

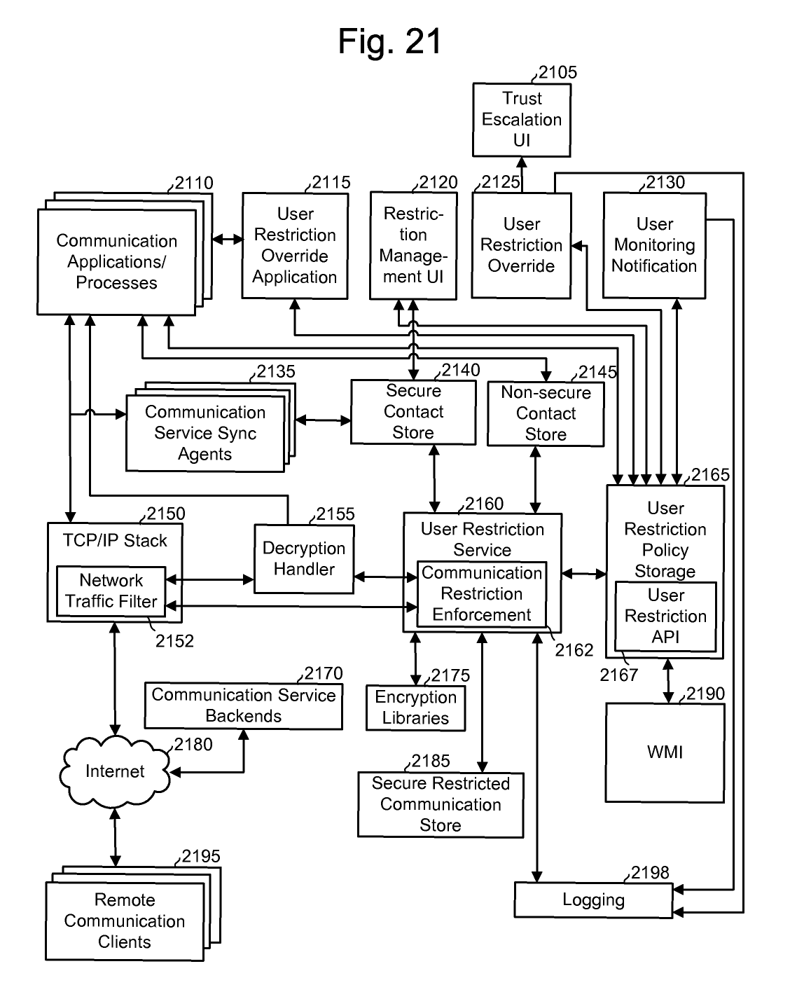

At step 330 (FIG. 3), if the authorized user decides to allow access, such as by selection of an “Allow access” button 1105 (FIG. 11), the blocked message is retrieved and provided to the monitored user (step 340). For example, the blocked message can be re-injected back into the application by which it was originally intended to be received, such as an e-mail application. The re-injection may be performed via a network stack such as a TCP/IP stack 2150 (FIG. 21). This can work for some forms of communication if the client application is currently actively communicating. If there is no client application to receive the communication, other mechanisms can be used, such as alerting the monitored user to the fact that a blocked message is now accessible, queuing the message for injection the next time the client application is active, or sending an entirely new message to the monitored user's mail server that is identified as “clean” by the filter on its next encounter. The user interface 1200 of FIG. 12 provides an example e-mail inbox which includes an entry 1210 for a blocked message, and an entry 1220 for the same message in a clear form. The message in the clear form is injected into the inbox after the blocked message. The entry 1220 can be selected, such as via a mouse or other pointing device, to view the unblocked content in an interface which is similar to the interface 1100 (FIG. 11).

If the blocked message is not appropriate, no harm is done as the monitored user has not yet been exposed to it, and the authorized user can simply delete the blocked message, or take other action such as reporting the message to a law enforcement agency or ISP, or communicating with the sender to request that no further messages be sent, for instance (step 350).

FIG. 4 illustrates a user interface 400 for configuring user restrictions. The user interface 400 allows the authorized user to configure the monitoring and restricting functionality as desired. The authorized user can choose from multiple types of controls and filters to be applied to each monitored user. The controls and filters can range from, e.g., completely unrestricted access, with or without activity logging, to no access whatsoever.

This example provides parental controls; however, other applications are possible. The user interface 400 includes the name of the child, “Toby”, which has been configured via another interface by the authorized user, e.g., the parent. The monitoring and restricting functionality can be configured differently for different users who log into the same host computer in different sessions. For example, different restrictions can be applied to a younger child than to an older child. Moreover, the parent may choose to turn the parental controls off when he or she logs in under his or her own session. Activity reporting can be enabled to provide a report of the monitored user's activities. Other settings can be configured as well, such as web filtering, which sets allowed web sites, downloads and other uses, and time limits which impose time/date limitations as to when the monitored user can use the computer, or specified applications on the computer. A games setting can be used to set age ratings, and to control games by content or title. A setting for blocking specific programs on the computer host can also be provided. Another setting is for blocking or allowing contacts, and controlling other use, for instant messaging and e-mail. Similar settings can be provided for other communications applications such as telephony. Finally, an activity report link allows the authorized user to view an activity report.

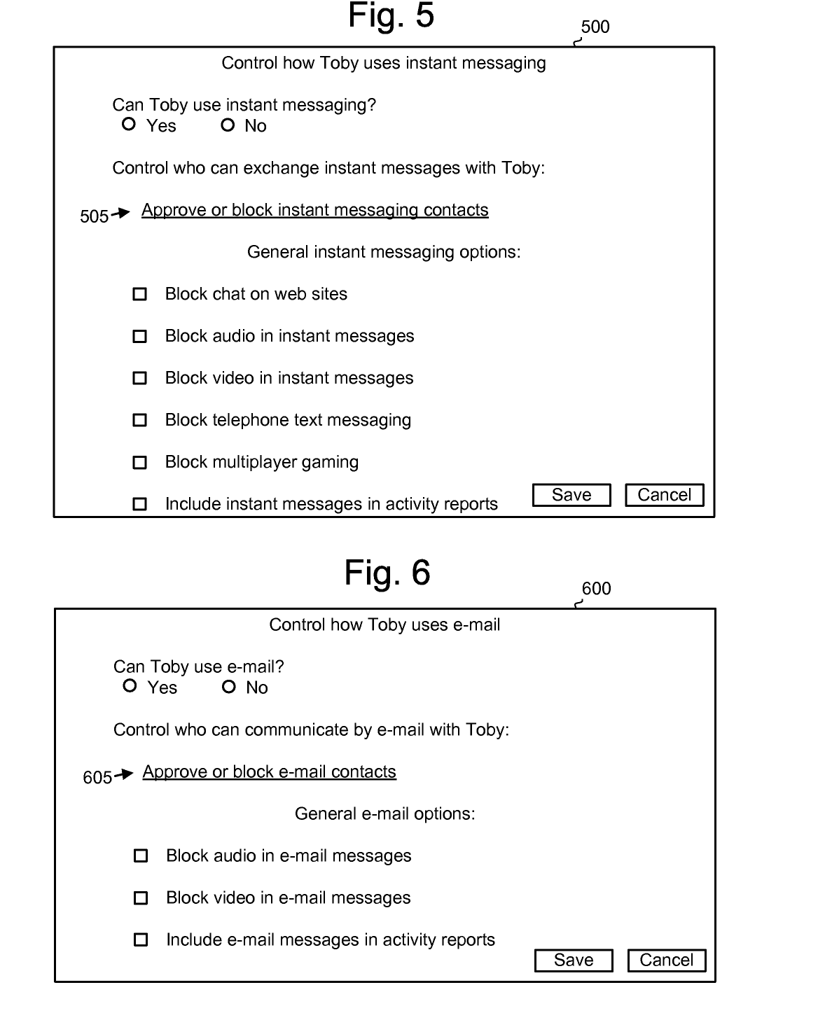

Each of the settings can be accessed by selecting a link which is represented by the underlined text to access an additional user interface. FIG. 5 provides an example user interface which is accessed by selecting the “Instant messaging” link in the interface 400, while FIG. 6 provides an example user interface which is accessed by selecting the “E-mail” link in the interface 400.

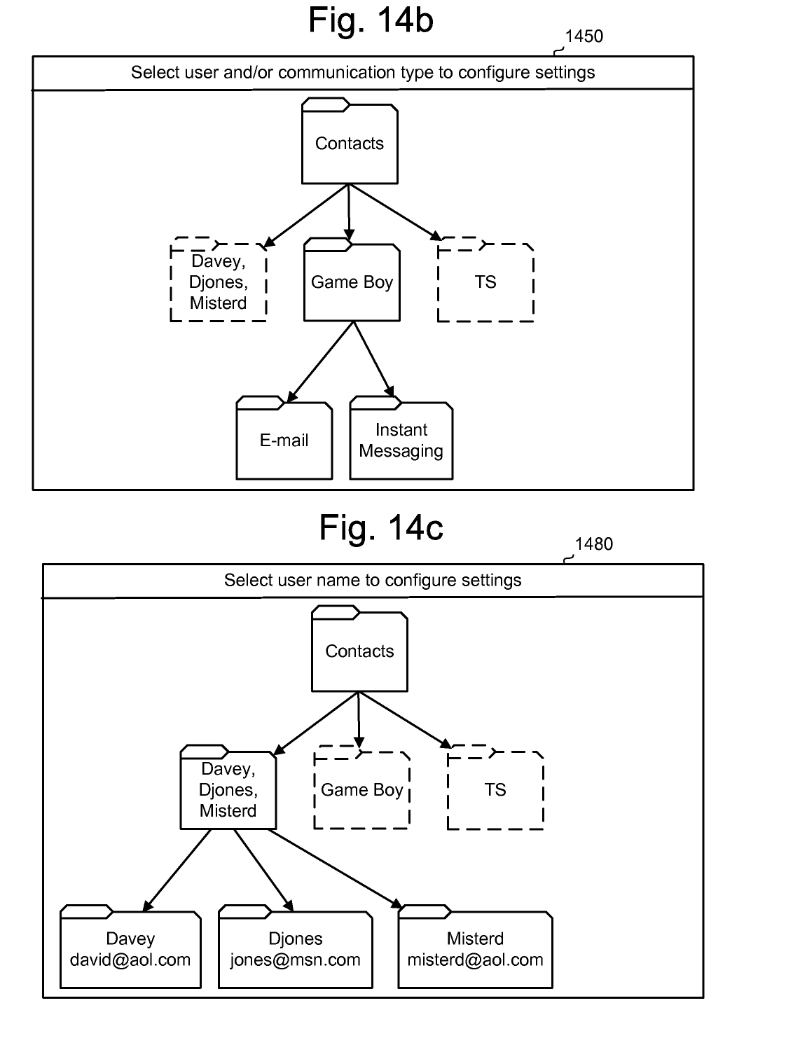

FIG. 5 illustrates a user interface 500 for setting up user restrictions for instant messaging. Through the selection of appropriate buttons, check boxes or other widgets, for instance, the user interface 500 allows the authorized user to indicate whether the monitored user, Toby, can use instant messaging. If Toby can use instant messaging or chat, additional options can be configured. By selecting the link 505, the authorized user can access a user interface 1400 (FIG. 14a) to approve or block instant messaging contacts, as discussed further below. The authorized user can also select from general instant messaging options such as blocking chat on web sites, blocking audio or video in instant messages, blocking telephone text messaging and blocking multiplayer gaming. The authorized user can also elect to include instant messages in the activity reports. The authorized user can select a save or cancel button to save the changes made or to cancel out of the interface 500.

FIG. 6 illustrates a user interface for setting up user restrictions for e-mail. The user interface 600 allows the authorized user to indicate whether the monitored user, Toby, can use e-mail. If Toby can use e-mail, additional options can be configured. By selecting the link 605, the authorized user can access the user interface 1400 (FIG. 14a) to approve or block e-mail contacts, as discussed further below. The authorized user can also select from general e-mail options such as blocking audio or video in e-mail messages, and including instant messages in the activity reports. The authorized user can select a save or cancel button to save the changes made or to cancel out of the interface 600.

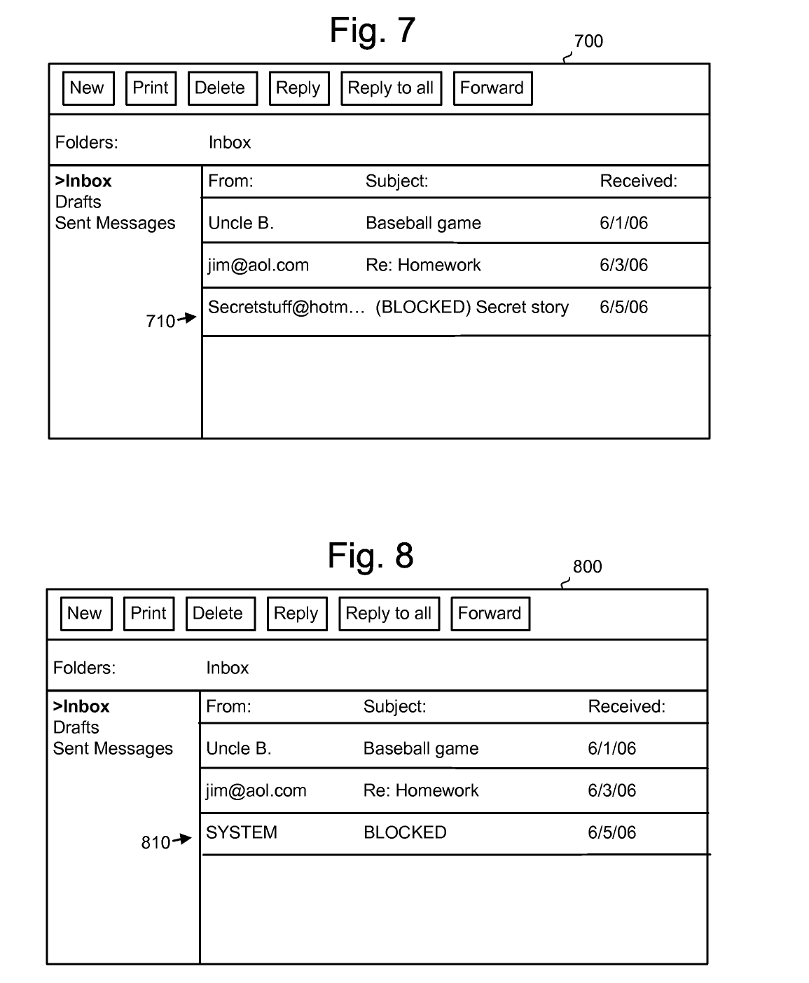

When an e-mail message is blocked, it can be concealed from the recipient, e.g., the monitored user, so that the monitored user does not know it was ever received and blocked. Or, information can be provided to the monitored user regarding the blocking, while concealing the content of the message, as described in connection with the examples user interfaces of FIG. 7 and FIG. 8.

FIG. 7 illustrates an inbox of an e-mail application of a monitored user showing a first format of a blocked message. In the example user interface 700, the inbox of a typical e-mail application is shown. The inbox includes e-mail messages from two senders, “Uncle B.” and “jim@aol.com”, which were not blocked. An e-mail message shown at entry 710 from a sender “Secretstuff@hotmail.com” has been blocked. In this case, the monitored user is allowed to view the sender and the subject of the e-mail message. The subject has been modified by the monitoring and restricting functionality by adding the text “(BLOCKED)”. Various other approaches can be taken. For example, the entry for the e-mail message can include an icon, or be presented in a special color, to indicate that the content of the e-mail message has been blocked. Blocked messages can be routed to a separate folder in the inbox.

FIG. 8 illustrates an inbox of an e-mail application of a monitored user showing a second format of a blocked message. In this format, the entry 810 for the blocked e-mail message provides essentially no information regarding the content of the e-mail message other than the fact that an e-mail message has been received and blocked. The date and time the e-mail message was received can also be provided. The text “SYSTEM” in the “From” field indicates that the monitoring and restricting functionality has provided the entry 810. The subject “BLOCKED” indicates that an e-mail message has been blocked.

FIG. 9 illustrates an e-mail message with an encrypted attachment of a blocked message. A similar user interface can be provided for other types of messages, e.g., instant messaging messages, telephony messages and gaming messages. For instant messaging messages, typically one or more incoming messages will be received. Since the monitored user cannot respond to a blocked message until it is unblocked, there is no two-way chat, and the messages represent a one-way communication. Similarly, a telephony message could be a voicemail message provided using VoIP, for instance, and a gaming message can be a message that is sent in the context of a multiplayer on-line game.

The user interface 900 appears when the monitored user opens a blocked e-mail message such as by selecting, e.g., double-clicking, the entry 810 of FIG. 8. The user interface 900 includes a header portion 910 which provides the sender, date, recipient and subject, and an indication that there is a file attached to the e-mail message. In this case, the monitoring and restricting functionality can generate a new e-mail message which includes the blocked message as an attachment. The attachment is provided in an access-restricted manner. For example, if the monitored user selects the indicia 915 of the attachment, i.e., a link titled “Filexyz”, he or she will be prompted to enter a password in order to view the attachment. Optionally, the attachment can be encrypted. Without the password, the monitored user cannot access the attachment. A body portion 920 of the user interface 900 includes a system message that informs the monitored user that a blocked e-mail is attached. Additionally, an indicia 925, titled “Request access”, can be selected by the monitored user to request access to the blocked e-mail message. Selection of this link is reflected in the activity report of the user interface 1000 of FIG. 10, under the heading “Access req.?”. The date the request was made can also be provided in the activity report.

To access the attachment, in one approach, the monitored user can request that the authorized user enter the password at the computer host of the monitored user. The monitored user can speak to the authorized user or contact the authorized user in another way to do this. In another approach, the authorized user can allow access by selecting a check box in the activity report (FIG. 10), for instance, or by selecting a button 1105 in a user interface 1100 (FIG. 11), which represents a view of the unblocked e-mail message. The authorized user can access the user interface 1100 through the activity report by selecting the subject “Secret story” in the user interface 1000. The activity report can be provided on the same computer host which the monitored user uses or on another networked computer host.

This feature provides pervasive in-place communication blocking for unmodified client communication applications and processes. Thus, there is no need to modify the e-mail application of the monitored user or the remote sender, for instance, in order to support the blocking mechanism. The system messages and attachments can be provided using the e-mail application tools which are already in place. Once the decision is made to block a message, based on monitoring of incoming network traffic, the message is captured in its entirety, optionally encrypted, and the encrypted version of the message is attached to a new message that is injected back into the incoming network traffic. The monitored user then sees the new message within the context of the client application he or she is using. The monitored user is informed that the message was blocked and that he or she will need to ask for an authorization in order to see the blocked communication. The link 925 within the injected message performs an authorization/override request when selected. The request can contain a unique identifier for the message. If the request is approved, the communication can subsequently be opened by selecting, e.g., double-clicking, the attachment via indicia 915. Selecting the attachment indicia 915 can invoke the authorization request and a decryption process as appropriate. After the message is decrypted, the original communication process, e.g., the e-mail application, is invoked to render the decrypted message, either by directly calling it or by inserting it back into the incoming network traffic.

In one approach, selecting the indicia 915 of the attachment can invoke a user contextual override using file extension association. Upon approval, the blocked communication which is allowed by the override can be recorded in a policy store (see user restriction policy storage 2165 in FIG. 21) as approved for the monitored user, and the decryption process, which invoked the override, decrypts the message, saves it into a formatted file, and invokes the e-mail application to open the file, again using file extension association. Since the identifier for the original attachment is recorded, the decryption process can continue to allow access to the encrypted attachment. An alternative, which avoids the need to save an override communication identifier, is to insert the original message in the incoming network stream while the client application is actively communicating.

FIG. 10 illustrates an activity report for e-mails of a monitored user. The user interface 1000 includes a region 1010 which allows the authorized user to select a date range for the activity report, or to show only new e-mails. A link to a statistical profile is also provided. The profile can indicate how many messages the monitored user has received in a given time period, which users he or she communicated with most frequently, and so forth. Similar activity reports can be provided for other types of communications such as instant messaging, telephony and chat. Activity reports can be provided for one or more monitored users. A region 1020 shows e-mail messages that were received by the monitored user in the reporting period. A check box provides filtering to display only blocked e-mail messages. For received email messages, the sender, subject and received date are shown, in addition to a status, which indicates whether or not the e-mail message was blocked, and the time and/or date of blocking. An additional field indicates whether access to a blocked e-mail message has been requested, and the date and/or time of the request. Check boxes are provided for the blocked e-mail message to enable the authorized user to provide access to the blocked message by the monitored user, or to delete the blocked message. The authorized user can select the subject of an e-mail message entry as a link which opens the full e-mail message. For example, selection of the subject “Secret story” for the blocked message results in display of the user interface 1100 of FIG. 11. The authorized user can thereby review the unblocked contents of a blocked e-mail message or other communication.

A region 1030 of the user interface 1000 shows e-mail messages that were sent by the monitored user in the reporting period. The authorized user can select the subject of an e-mail message entry as a link which opens the full e-mail message to thereby review the contents of the sent message.

FIG. 11 illustrates a blocked e-mail which is read via an activity report. As mentioned, the authorized user can review the unblocked contents of a blocked e-mail message or other communication via the activity report. The user interface 1100 provides a view of a blocked e-mail message in its original, clear form. The header portion 1110 includes the sender, date and time, recipient, and subject. The body portion 1120 includes the full e-mail contents, which in this example includes a link 1125 to a web site which can be selected by the authorized user. As desired, the authorized user can select an “Allow access” 1105 button to allow the monitored user to access the blocked e-mail message. Selection of this option causes the unblocked e-mail message to be provided to the monitored user's inbox, as indicated by the user interface 1200 of FIG. 12. Other options in the user interface 1100 allow the authorized user to reply to, forward, print or delete the message.

FIG. 12 illustrates an inbox of an e-mail application of a monitored user showing a previously blocked e-mail for which access was authorized. In the user interface 1200, the entry 1210 for the blocked e-mail message, as seen in the interface 800 of FIG. 8, can remain in the inbox. The unblocked version of the e-mail message is indicated by the entry 1220. Note that an example additional unblocked message from a sender “oldjoe@msn.com” was received on Jun. 6, 2006, after the blocked e-mail was received. The unblocked version of the e-mail message was received in the inbox on Jun. 8, 2006, which is three days after the original message was received on Jun. 5, 2008, due to the time taken for the authorized user to authorize access. In this approach, the entry 1210 relating to the blocked message can be deleted by the monitored user. In another approach, the inbox can be automatically refreshed to remove the entry 1210 when the unblocked version of the e-mail message is received.

In one approach, a secure write-only store is used to store a blocked message. The monitored user receives a new communication, such as an e-mail message, with a pointer to a restricted file in the store which contains the blocked message. Selecting the link invokes the user contextual override as discussed previously to allow access to the write-only store in the same manner used by the decryption process, including re-injecting the traffic if desired. In another approach, a password can be provided to the monitored user by e-mail, for instance, for accessing the blocked message attachment, such as by selecting the indicia 915 (FIG. 9) and entering the password.

FIG. 13a illustrates a process for obtaining contact information for a shared allow/block contact list. A shared allow/block contact list can be provided to enhance the ability to monitor the communications of a monitored user. The shared allow/block contact list can be provided using information from different communication types and/or service providers/vendors, for instance. The different communication types can include, e.g., e-mail, instant messaging, telephony and chat, while the different service providers can include companies that provide communications software, e.g., AOL®, MSN®, Google® and others. Contacts identify users who communicate with the monitored user. Such users can be identified by an e-mail address, screen name or the like. The shared contact list can therefore be created from multiple sources, and can be effective across multiple communication methods/applications/processes.

At step 1300, service providers provide user identifiers and associated user names to the computer host of the monitored user, or to a network location which is in communication with the computer host of the monitored user. For example, the user identifier can be any identifier of a user, such as an account number, social security number, or primary e-mail address. The identifier is preferably unique. For example, e-mail addresses are suitable identifiers because they are unique. The associated user names can be any name which is used by a user, such as a screen name, and need not be unique. See the related discussion in connection with FIG. 14a. At step 1310, the computer host stores the information in a secure contact store. The information provided by the service providers is sensitive and therefore should be secured. The secure contact store can be set up for a service provider sync agent using a secure certification process that ensures that only that service provider and the monitoring and restricting functionality will have access to the information and settings stored there. See FIG. 21. The monitoring and restricting functionality can also be secured to prevent harvesting of data by external processes.

Other types of contact information are less sensitive and can be stored in a non-secure contact store if desired. For example, at step 1320, the communications applications at the computer host of the monitored user can automatically detect new contacts. A new contact can be created for each new user with which the monitored user communicates, based on sent or received e-mail message, instant messages and the like. Similarly, existing contacts from different applications can be combined into one location. At step 1330, the monitored user adds new contacts via an appropriate user interface and, at step 1340, the authorized user adds new contacts via an appropriate user interface. At step 1350, the computer host stores the information in a non-secure contact store.

With this approach, different contacts, such as for a user “Fred Smith”, have the same meaning and represent the same person regardless of the method of communication used. This provides a powerful and intuitive way to regulate communication with individuals. Contacts from various services can also be combined in a secure fashion and correlated based on a key unique identifier, such as an email address, social security number of the like. A contact can have multiple identifiers associated with it, such as a screen name, but it will always be recognized individually by its key identifier. Given the key identity, a particular individual's communication with the monitored user can be regulated based on the policy set up by the authorized user. In other words, if the authorized user configures the monitoring and restricting functionality so that the monitored user can no longer communicate with “Fred Smith”, the monitored user will not be able to communicate with that individual regardless of what application, communication mode, or service provider Fred or the monitored user attempt to use. The authorized user can configure the monitoring and restricting functionality in this way using the user interface 1400 of FIG. 14a.

FIG. 13b illustrates a process for determining an allow or block status of a contact in a shared allow/block contact list. At step 1360, a user name such as a screen name is obtained from a monitored message. E-mail messages, instant messaging messages and other communications typically include a user name identifier which can be readily extracted. At step 1370, the user name is associated with a unique user identifier, such as by cross-referencing the user name to a list of unique user identifiers. At step 1380, an allow or block status is determined based on the unique user identifier. In another approach, at step 1390, the unique user identifier is obtained from the message itself, and the allow or block status is determined at step 1380. For example, the unique user identifier can be an e-mail address which is included in a message. Note that steps 1360 and 1390 can be performed as part of step 210 of FIG. 2, which involves extracting information from messages of a monitored user. Also, steps 1370 and 1380 can be performed as part of step 215 of FIG. 2, which involves checking the contact list and other restriction conditions.

FIG. 14a illustrates a user interface for configuring a shared allow/block contact list. The user interface 1400 provides a contact list which includes a name, such as a screen name, an identifier such as an e-mail address, and an indication of the programs which are associated with the contacts. Check boxes allow the authorized user to indicate the type of communication which is allowed, such as e-mail and/or instant messaging (IM). Check boxes can also be provided for configuring other options such as telephony and chat. The user interface 1400 indicates that the first three entries 1410 are multiple user names which are associated with the same user. The fourth and fifth contacts are users who have one user name each. Thus, the authorized user can configure the access for specific users from among those users listed in the contacts. Check boxes control access for each of the user names, or for a group of user names which are associated with the same user, and are provided based on the communication mode or modes which are associated with the name. For example, two check boxes, one for e-mail and one for IM, are provided for the group of user names associated with one user.

For example, assume a user “David Jones” has three user names. The first user name, “Davey”, is used for instant messaging in the program AOL Instant Messenger® (AIM), and there is an associated e-mail address david@aol.com. Instant messaging typically works in conjunction with an e-mail address even when an e-mail is not sent. That is, the IM service provider typically has an e-mail name associated with screen names for their own records. However, the service provider may use some other form of identity for the user. The second user name “Djones” is used for e-mail in the program Outlook®, and for instant messaging in the program MSN Messenger®, and there is an associated e-mail address jones@msn.com. The third user name “Misterd” is used for e-mail in the program Outlook® with the associated e-mail address misterd@msn.com. Similarly, for the second user, the user name “Game Boy” is used for e-mail in the program Yahoo®, and for instant messaging in the program ICQ, with the associated e-mail address timmyp@yahoo.com. For the third user, the user name “TS” is used for e-mail in the program Gmail®, and for instant messaging in the program Google Talk®, with the associated e-mail address tomsmith@gmail.com. Each of the above-mentioned programs is provided by associated service providers.

FIG. 14a thus illustrates how a user can use different user names in different communication applications of different service providers. Also, the user can use the same user name in the communication applications of different service providers. In either case, the user can be uniquely identified based on his or her user identifier. In one option, a check box allows the authorized user to block anyone that is not in the list from communicating with the monitored user. Links can also be provided to allow the authorized user to view recent e-mail activity (FIG. 10) or instant messaging activity in an activity report. The authorized user can select a save or cancel button to save the changes made or to cancel out of the interface 1400.

FIG. 14b illustrates a tree view user interface for a shared allow/block contact list, arranged by user and communication type. The user interface 1450 includes a folder for each user at different nodes of a tree. The authorized user can select one of the folders (nodes) which represents a particular user, such as the folder for the user “Game Boy”, and drill down to additional subfolders to configure settings for the different communication types. For example, when the “Game Boy” folder is selected, as indicated by the folder with the solid lines, corresponding folders titled “E-mail” and “Instant Messaging” are displayed. Thus, only the modes of communication which apply to the particular user are displayed, in one option. In this case, “TS” does not communicate with the monitored user using other modes such as telephony and chat. The authorized user can then select one of the folders “E-mail” or “Instant Messaging” to access a corresponding interface which allows settings to be configured for the user. Or, the authorized user can right-click on the folder icon to access a pop-up menu for providing a configuration setting, e.g., such as “allow” or “block”.

FIG. 14c illustrates a tree view user interface for a shared allow/block contact list, arranged by user. The user interface 1480 includes a folder for each user name, or group of user names which are associated with the same user, at different nodes of a tree. The authorized user can select one of the folders (nodes) which represents a particular user name or group of user names, such as the folder for the group of user names “Davey, Djones, Misterd”, and drill down to additional subfolders to configure settings for the individual user names. For example, when the “Davey, Djones, Misterd” folder is selected, as indicated by the folder with the solid lines, corresponding folders titled “Davey”, “Djones” and “Misterd” are displayed. For the users “Game Boy” and “TS”, there are no subfolders because there are no additional associated user names. The authorized user can then select one of the folders to access a corresponding interface which allows settings to be configured for the user name. Or, the authorized user can right-click on the folder icon to access a pop-up menu for providing a configuration setting, e.g., such as “allow” or “block”.

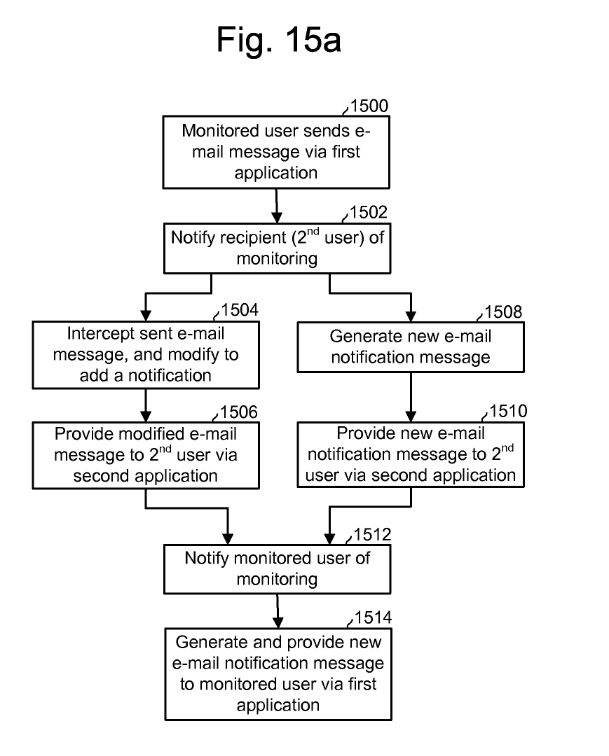

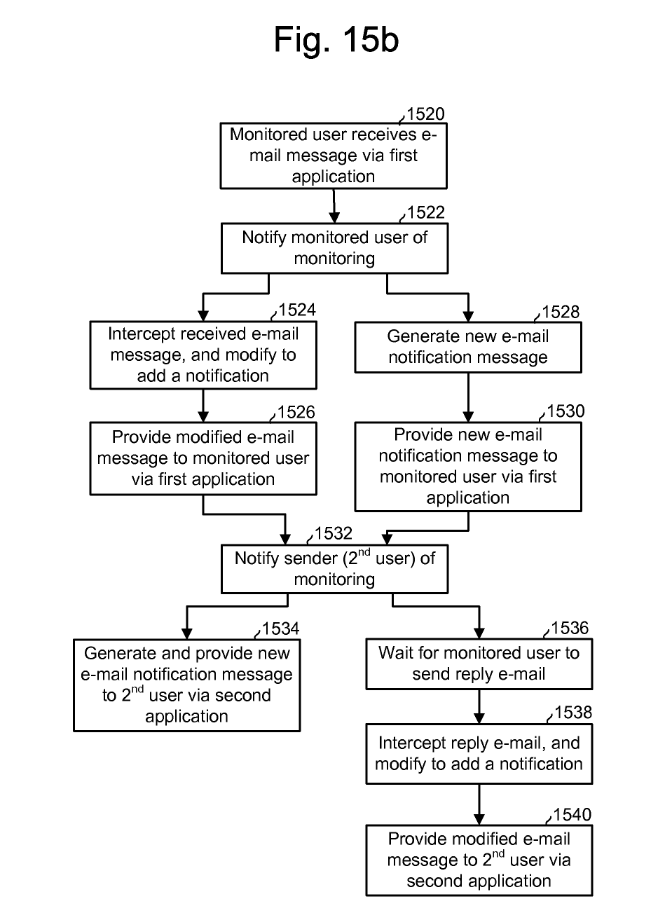

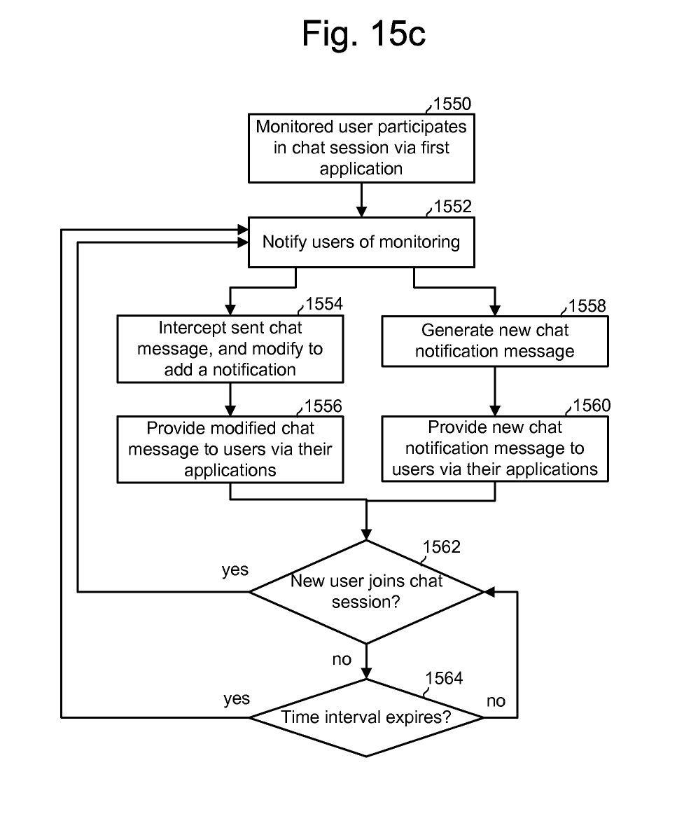

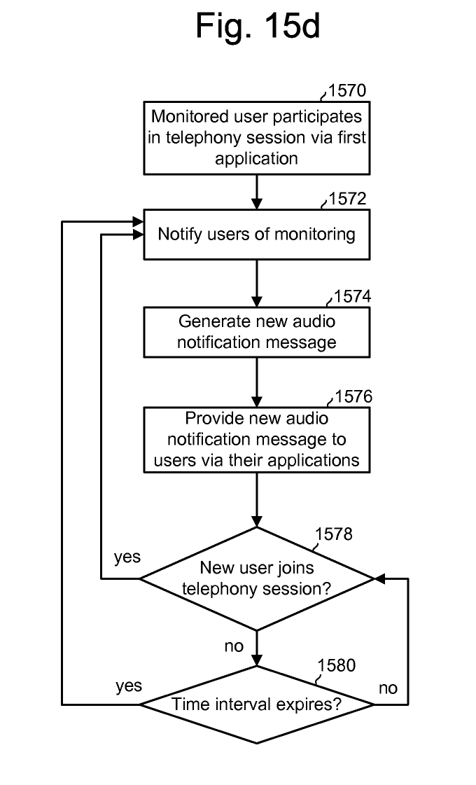

FIGS. 15a-d illustrates processes for notifying users of monitoring. To address legal and ethical concerns in monitoring communications, a notification process may be used for informing users that their communications are being monitored. All parties participating in a communication may need to be informed that the communication is being recorded and otherwise monitored. The notification can take many forms based on the communication type. The notification can rely, e.g., on injecting new content into the communication for informing the users about the monitoring, or a compliant communication application appending the information to the communication directly.

In some cases it may be desirable to notify a user of the monitoring before the user contributes to the communication. For example, with e-mail, a footer or signature can be added to all outgoing e-mail messages indicating that the communication is being monitored. With instant messaging, a new notification message can be sent when a new user joins the chat. The notification can be appended to each message with each subsequent reply, and/or provided at desired time intervals. If an incoming e-mail is recorded and not replied to immediately, one approach is to start bouncing all additional messages from this user. Although a viable option, sending a notification message automatically in this case may not be desirable because it encourages external spamming attacks by confirming the validity of the recipient's e-mail address.

Various benefits can be achieved by notifying users of the monitoring through the same application being used for sending or receiving communications, such as an e-mail, instant messaging, telephony or chat application. For example, the notification can be provided without modifying the existing applications, and in a manner which is appropriately visible to the user. Furthermore, a notification can be provided at an appropriate time in the communication process. For example, this can be when a new messaging session begins, such as an instant message session, when a new user joins a session, when a message is sent or received, such as an e-mail or telephony message, or as a notification period elapses, in which case a notification is provided periodically, e.g., every few minutes.

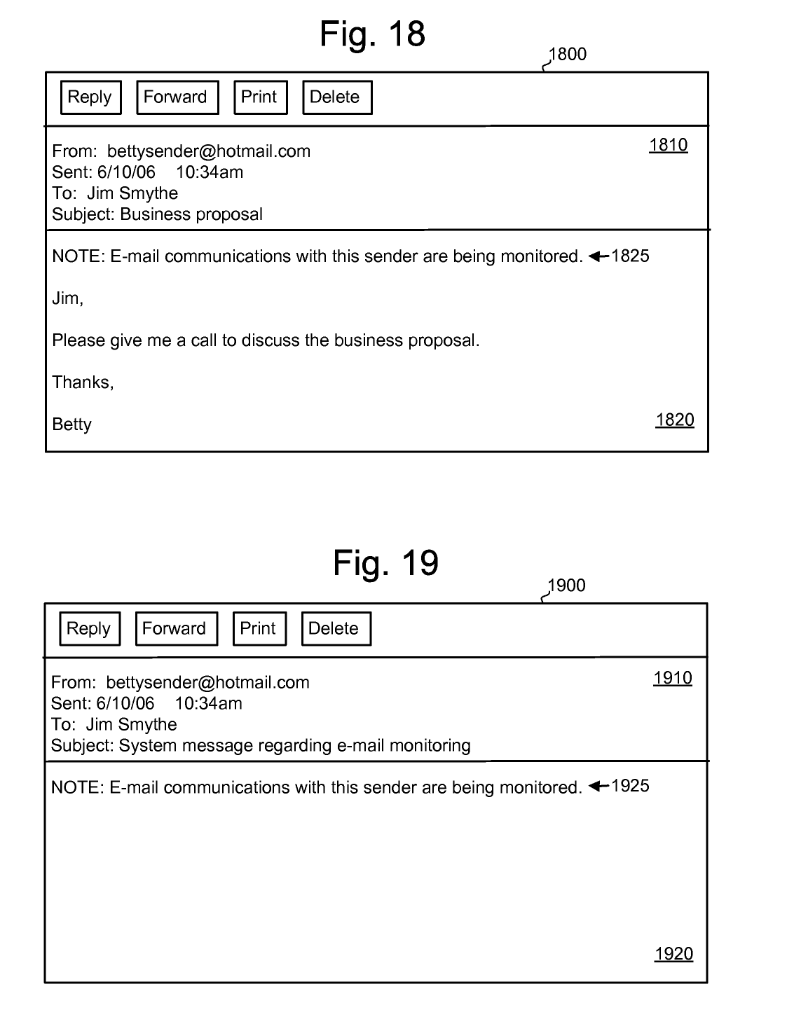

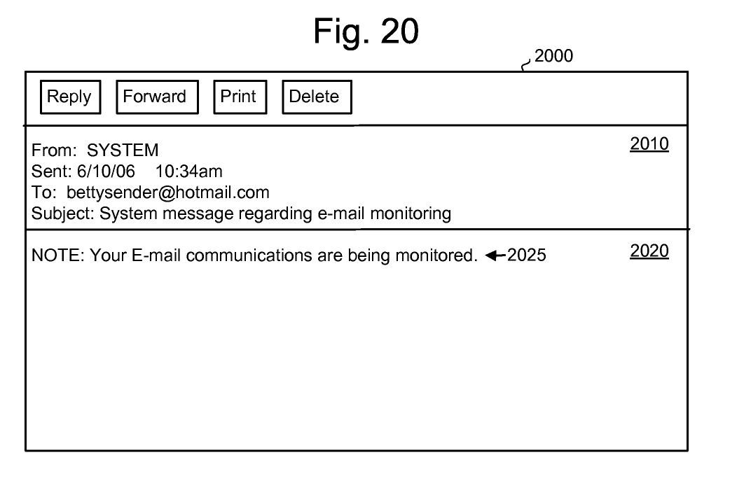

FIG. 15a illustrates a process for notifying e-mail users of monitoring. At step 1500, a monitored user sends an e-mail message via a first communications application. At step 1502, a process begins for notifying the recipient of the e-mail, a second user, of the monitoring. This can be achieved in two ways, for instance. Both approaches can be used as well. In one approach, at step 1504, the sent e-mail is intercepted and modified to add a notification, such as indicated by the user interface 1800 (FIG. 18), and, at step 1506, the modified message is provided to the second user via a second communications application, which is not necessarily the same as the first communications application. For example, the communications applications can be provided by different service providers, e.g., MSN® and Yahoo®. In another approach, at step 1508, a new e-mail notification message is generated and, at step 1510, the new notification message is provided to the second user via the second communications application, such as indicated by the user interfaces 1900 (FIG. 19) and 2000 (FIG. 20). At step 1512, the user can also be notified of the monitoring. For example, at step 1514, a new e-mail notification message can be generated and provided to the monitored user via the first communications application. A notification icon can also be displayed in the system tray of the monitored user.

FIG. 15b illustrates another process for notifying e-mail users of monitoring. At step 1520, a monitored user receives an e-mail message via a first communications application. At step 1522, a process begins for notifying the monitored user of the monitoring. This can be achieved in two ways, for instance. Both approaches can be used as well. In one approach, at step 1524, the received e-mail is intercepted and modified to add a notification, and, at step 1526, the modified message is provided to the monitored user via the first communications application. In another approach, at step 1528, a new e-mail notification message is generated and, at step 1530, the new notification message is provided to the monitored user via the first communications application. At step 1532, the sender of the e-mail message received at step 1520, a second user, can also be notified of the monitoring. This can be achieved in two ways, for instance. Both approaches can be used as well. For example, at step 1534, a new e-mail notification message can be generated and provided to the second user via a second communications application. Or, at step 1536, a wait can be implemented until the monitored user sends a reply e-mail. At step 1538, when the monitored user sends a reply, the reply is intercepted and modified to add a notification, and, at step 1540, the modified e-mail message is provide to the second user via the second communications application.

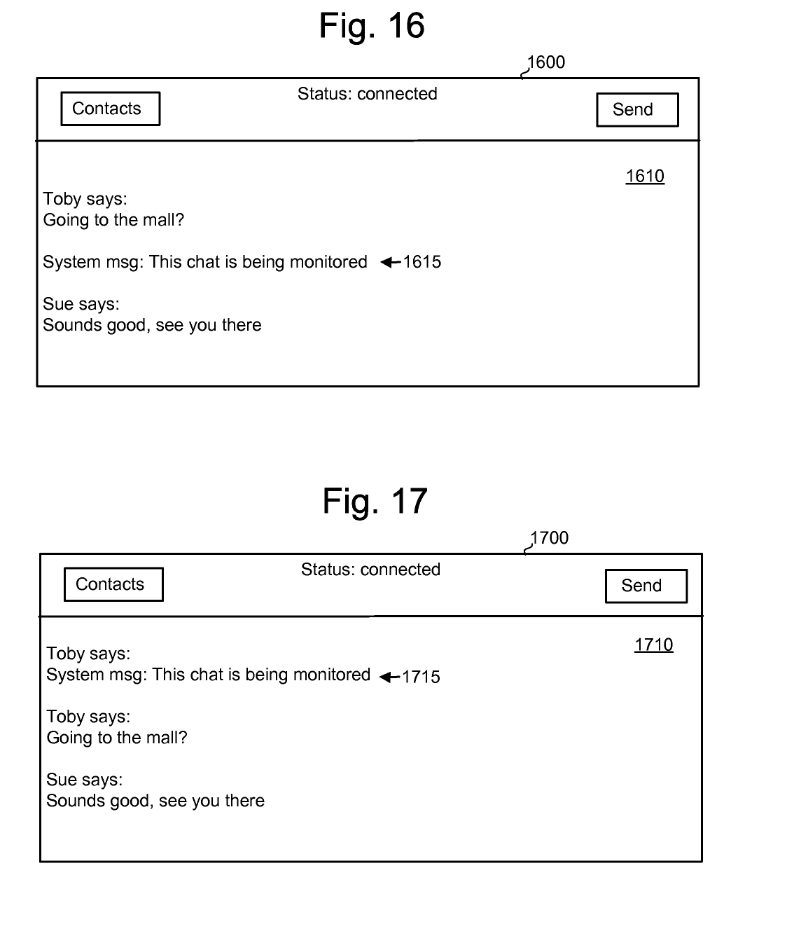

FIG. 15c illustrates a process for notifying chat session users of monitoring. At step 1550, a monitored user participates in a chat session via a first communications application. At step 1552, a process begins for notifying the users of the monitoring. This can be achieved in two ways, for instance. Both approaches can be used as well. In one approach, in which all of the participating users can be notified, at step 1554, a sent chat message, such as from the monitored user, is intercepted and modified to add a notification, and, at step 1556, the modified message is provided to the users via their associated communications applications, such as indicated by the user interface 1600 of FIG. 16. For example, the message text from Toby which asks “Going to the mall?” is augmented to include the text “System msg: This chat is being monitored”. An additional message from a user “Sue” is subsequently displayed. The communications applications of the users can be different. For example, they may be messaging applications provided by MSN Messenger® and AIM®. In another approach, at step 1558, a new chat notification message is generated and, at step 1560, the new notification message is provided to the users via their associated communications applications, such as indicated by the user interface 1700 of FIG. 17, which includes the text “System msg: This chat is being monitored”. Additional messages from Toby and Sue are subsequently displayed. At step 1562, if a new user joins the chat session, the notification process is repeated at step 1552. Also, at step 1564, if a time interval expires, the notification process is repeated at step 1552. The time interval can be a few minutes or other value which provides a reasonably frequent notification without being unduly intrusive.

FIG. 15d illustrates a process for notifying telephony session users of monitoring. At step 1570, a monitored user participates in a telephony session, which can be a phone call with one or more other users, via a first communications application. At step 1572, a process begins for notifying the users of the monitoring. At step 1574, a new audio notification message is generated and, at step 1576, the new audio notification message is provided to the users via their associated communications applications. For example, the communications applications can be associated with different service providers such as Vonage® and Skype®. The audio message can state: “This phone call is being monitored”. The audio message can be inserted at the start of the phone call and/or at periodic intervals thereafter, for instance. At step 1578, if a new user joins the telephony session, the notification process is repeated at step 1572. Also, at step 1580, if a time interval expires, the notification process is repeated at step 1572. The time interval can be a few minutes or other value which provides a reasonably frequent notification without being unduly intrusive.

FIG. 16 illustrates an instant message 1600 which has been modified to include a notification of monitoring 1615 as part of a user-generated message in a message region 1610. A message from a user Sue is subsequently sent. FIG. 17 illustrates a newly generated instant message 1700 which includes a notification of monitoring 1715 as a separate message in a message region 1710. Messages from Toby, the monitored user, and Sue, are subsequently sent.

FIG. 18 illustrates an e-mail message 1800 which has been modified to include a notification of monitoring 1825 at the beginning of a message region 1820. The message 1800 also includes a conventional header region 1810. FIG. 19 illustrates a newly generated e-mail message 1900 which includes a notification of monitoring 1925 for a recipient in a message region 1920. The message 1900 also includes a header region 1910 indicating that a subject of the e-mail message relates to monitoring. FIG. 20 illustrates a newly generated e-mail message 2000 which includes a notification of monitoring 2025 for a sender in a message region 2020. The message 2000 also includes a header region 2010 indicating that the e-mail was generated by the monitoring system, and a subject of the e-mail message relates to monitoring.

FIG. 21 illustrates a communications restriction architecture for implementing the features discussed herein. The architecture provides a monitoring and restricting functionality that can be tightly integrated with the operating system to allow not only broad enforcement but provide flexibility and discoverability. The monitoring and restricting functionality works across multiple applications, without modifying the applications being controlled, allows preservation and recording of communications, even in blocked scenarios, enables richer blocking ability, e.g., context based blocking, maintains security, and notifies users of ongoing monitoring. The monitoring and restricting functionality can be built into the operating system so that it is provided between the communication application and the network server. A richer experience can be enabled via an API for applications that wish to do so and can provide more context. These applications can determine if a block would occur before it does and enable override requests and other customizations of the implementation of the restriction. These restrictions can be applied to all forms of user communication.

Referring to the architecture, communications applications/processes 2110, which communicate over the Internet 2180 via a TCP/IP stack 2150, can include e-mail, instant messaging, telephony, chat and so forth, as discussed. The communication applications/processes 2110 also provide a request for an override, via an API, to a user restriction policy storage 2165. The communication applications/processes 2110 can provide contacts to a non-secure contact store 2145, based on automatically detected contacts or contacts added by the monitored or authorized users, for instance.

A user restriction override application 2115, which can be provided as a protocol handler executable, receives a request for an override of a blocked message, via a link (see, e.g., the “request access” link 925 in FIG. 9), from the communication applications/processes 2110.

A restriction management user interface (UI) 2120 provides user interfaces (e.g., FIGS. 4, 5, 6, 10, 11 and 14a-c) for use by the authorized user in configuring settings, and communicates with the user restriction policy storage 2165 to get and set user policies, e.g., configuration settings.

A user restriction override function 2125, which can be provided as a Microsoft® COM (Component Object Model) object, for instance, brings up a dialogue which asks the authorized user if the monitored user is allowed to access a blocked message, for instance, and communicates with a trust escalation UI 2105 to invoke an escalation to authorize an override. In particular, the trust escalation UI 2105 can bring up a dialogue which asks the authorized user to enter a password, for instance, to authorize the override. The user restriction override function 2125 also communicates with the user restriction policy storage 2165 to launch an override and return the result, and to unblock access to the blocked message. The result indicates whether the override was successful, e.g., whether the authorized user selects “ok” or “cancel”.

A user monitoring notification function 2130, which can be provided as an executable, provides notifications as discussed, including providing a notification icon in a system tray, and gets user settings from the user restriction policy storage 2165.

Communication service sync agents 2135, which communicate over the Internet 2180 via the TCP/IP stack 2150, manage the replication of policies and settings to the client, e.g., the local client machine on which the agent is installed, such as by obtaining contact information from different service providers for use in providing the shared allow/block contact lists, and keeping this information synchronized with the data of the service providers. One or more agents can be provided for each service provider, for instance. The communication service sync agents 2135 are responsible for keeping their local secured contact list up-to-date. This information is readable only by the sync agent itself and the Windows OS components responsible for exposing and implementing the communication restrictions, in one possible approach.

A secure contact store 2140 is a write-only store that stores the contact lists and settings, and communicates with the restriction management UI 2120 to provide secure contact and settings management. A non-secure contact store 2145 stores contacts which are provided by the communication applications/processes 2110.

The user restriction policy storage 2165 stores policy/configuration data for setting filtering on or off, logging on or off, allow/block statuses, and so forth, based on the authorized user's inputs. The policy data is accessed whenever a message is received to determine if the message is restricted. The user restriction policy storage 2165 also communicates with the user monitoring notification function 2130 to get user settings, and communicates with the user restriction service 2160 to get filter settings/blocks, including allow/block information and allow communication overrides. A user restriction API 2167 is used for override requests and activity blocking.

A TCP/IP stack 2150, which includes a network traffic filter 2152, communicates via the Internet 2180 with remote communication clients 2195. These represent the network users that the monitored user is communicating with, such as the user 100 (FIG. 1), via their associated communications applications. The network traffic filter 2152 monitors the network traffic to locate messages that meet a restriction condition as discussed, in addition to figuring out what protocol is being used, and providing data to the communication restriction enforcement function 2162 regarding whether a communication is blocked, and the reason why.

A decryption handler 2155, which can be provided as an executable or COM object, for instance, handles decryption of encrypted message which are stored in the secure restricted, write-only communication store 2185, based on an allow override message from the communication restriction enforcement function 2162. The decryption handler 2155 can also send a view request to the network traffic filter 2152 to decrypt the communication if it is inserted back into the incoming network traffic.

The user restriction service 2160 determines whether a message should be blocked. It takes messages from the network traffic filter 2152 and policy data from the user restriction policy storage 2165 to determine whether the message is restricted, in which case the message can then be encrypted and sent to the secure restricted communication store 2185. The user restriction service 2160 also accesses the secure contact store 2140 or the non-secure contact store 2145 to determine if a contact is blocked. The communication restriction enforcement function 2162 can communicate with the secure restricted communication store 2185 to store and retrieve messages.

Communication service back ends 2170, which can include a web service such as MSN®, Yahoo®, AOL®, etc., provide contact information in web server sync traffic.

Encryption libraries 2175 perform encryption and communicate encrypted messages to the communication restriction enforcement function 2160.

A Windows Management Interface (WMI)+2190 can be used as one possible way to expose the settings API.

Remote communication clients 2195 represent the network users with which the monitored user communicates.

The logging function 2198 provides logging of messages for activity reporting, receives requests to subscribe to events from the user monitoring notification function 2130, receives write override events from the user restriction override function 2125, and receives write activity events from the user restriction service 2160.

To understand the architecture of FIG. 21 further in connection with the process of FIG. 2, note that step 200, setting user restrictions on, involves the authorized user providing policy settings via user interfaces provided by the restriction management UI 2120, and the user restriction policy storage 2165 storing the settings. Step 210, extracting information from messages, involves the network traffic filter 2152. Step 215, checking a contact list and other restriction conditions, involves the user restriction service 2160 and the secure contact store 2140. Step 220, determining if the received message is restricted, and step 230, determining if activity reporting is on, involve the user restriction service 2160. Step 240, adding to an activity report, involves the user restriction service 2160 and the logging function 2198. Step 250, determining if blocking is activated, involves the user restriction service 2160. Step 260, intercepting and storing messages under access-control, involves the user restriction service 2160, encryption libraries 2175, and the secure restricted communication store 2185.

To understand the architecture of FIG. 21 further in connection with the process of FIG. 3, note that step 300, determining when a monitored user requests access to a blocked message, involves the communications applications/processes 2110 and the user restriction override application 2115. Step 310, in which the authorized user views an activity report, involves the restriction management UI 2120. Step 320, in which the authorized user accesses and reviews a blocked message, and step 330, in which it is determined whether the authorized user has granted access to the blocked message, involve the user restriction override function 2125 and the trust escalation UI 2105. Step 350, in which a blocked message is retrieved and provided to the monitored user, involves the user restriction override application 2115, the user restriction override function 2125, the user restriction policy storage 2165, the user restriction service 2160, the encryption libraries 2175, the secure restricted communication store 2185, the decryption handler 2155 and the communication applications/processes 2110. Step 350, in which a blocked message is deleted, involves the restriction management UI 2120.

To understand the architecture of FIG. 21 further in connection with the process of FIG. 13a, note that steps 1300 and 1310, relating to storing secure contact information from service providers, involve the TCP/IP stack 2150, the communication service sync agents 2135, and the secure contact store 2140. Steps 1320, 1330, 1340 and 1350, relating to storing non-secure contact information, involve the communication applications/processes 2110 and the non-secure contact store 2145.

To understand the architecture of FIG. 21 further in connection with the process of FIG. 13b, note that steps 1360 and 1390, relating to obtaining user names or unique identifiers, involve the network traffic filter 2152, and steps 1370 and 1380, relating to associating a user name with a unique identifier, and determining an allow or block status, involve the user restriction service 2160 and the secure contact store 2140.

To understand the architecture of FIG. 21 further in connection with the process of FIGS. 15a-d, note that steps which relate to providing notifications involve the user restriction service 2160, the TCP/IP stack 2150 and the communication applications/processes 2110. All restrictions can be implemented via a network stack plugin and a number of network protocol filters. A particular protocol (e.g., the POP3 e-mail protocol) is identified, and the contact allow/block list or other mechanism is used to decide whether or not to block a message.

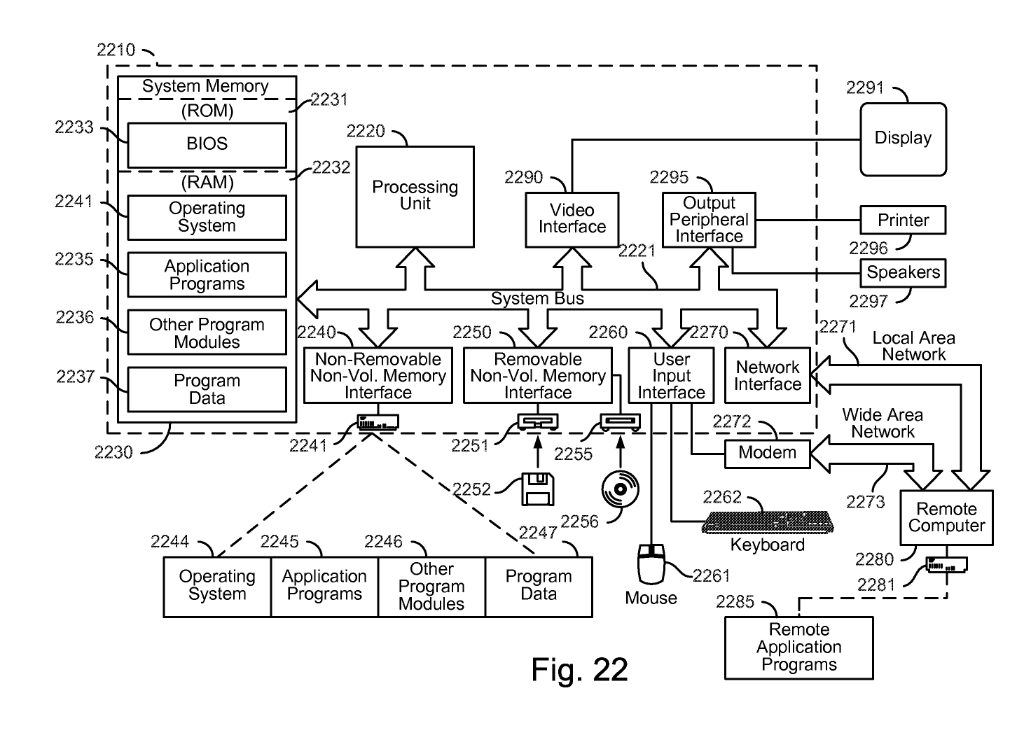

FIG. 22 is a block diagram of computer hardware suitable for implementing embodiments of the invention. An exemplary system for implementing the invention includes a general purpose computing device in the form of a computer 2210. The computer 2210 may represent any of the computer hosts 105, 125 and 135 (FIG. 1), for instance. Components of computer 2210 may include, but are not limited to, a processing unit 2220, a system memory 2230, and a system bus 2221 that couples various system components including the system memory to the processing unit 2220. The system bus 2221 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 2210 typically includes a variety of computer readable media. Computer readable media can be any available media that can be accessed by computer 2210 and includes both volatile and nonvolatile media, removable and non-removable media. By way of example, and not limitation, computer readable media may comprise computer storage media and communication media. Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 2210. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above are also included within the scope of computer readable media.

The system memory 2230 includes computer storage media in the form of volatile and/or nonvolatile memory such as read only memory (ROM) 2231 and random access memory (RAM) 2232. A basic input/output system 2233 (BIOS), containing the basic routines that help to transfer information between elements within computer 2210, such as during start-up, is typically stored in ROM 2231. RAM 2232 typically contains data and/or program modules that are immediately accessible to and/or presently being operated on by processing unit 2220. By way of example, and not limitation, FIG. 22 illustrates operating system 2234, application programs 2235, other program modules 2236, and program data 2237.

The computer 2210 may also include other removable/non-removable, volatile/nonvolatile computer storage media. By way of example only, FIG. 22 illustrates a hard disk drive 2241 that reads from or writes to non-removable, nonvolatile magnetic media, a magnetic disk drive 2251 that reads from or writes to a removable, nonvolatile magnetic disk 2252, and an optical disk drive 2255 that reads from or writes to a removable, nonvolatile optical disk 2256 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 2241 is typically connected to the system bus 2221 through a non-removable memory interface such as interface 2240, and magnetic disk drive 2251 and optical disk drive 2255 are typically connected to the system bus 2221 by a removable memory interface, such as interface 2250.

The drives and their associated computer storage media discussed above and illustrated in FIG. 22, provide storage of computer readable instructions, data structures, program modules and other data for the computer 2210. For example, hard disk drive 2241 is illustrated as storing operating system 2244, application programs 2245, other program modules 2246, and program data 2247. These components can either be the same as or different from operating system 2234, application programs 2235, other program modules 2236, and program data 2237. Operating system 2244, application programs 2245, other program modules 2246, and program data 2247 are given different numbers here to illustrate that, at a minimum, they are different copies. A user may enter commands and information into the computer 2210 through input devices such as a keyboard 2262 and pointing device 2261, commonly referred to as a mouse, trackball or touch pad. Other input devices (not shown) may include a microphone, joystick, game pad, satellite dish, scanner, or the like. These and other input devices are often connected to the processing unit 2220 through a user input interface 2260 that is coupled to the system bus, but may be connected by other interface and bus structures, such as a parallel port, game port or a universal serial bus (USB). A monitor 2291 or other type of display device is also connected to the system bus 2221 via an interface, such as a video interface 2290. In addition to the monitor, computers may also include other peripheral output devices such as speakers 2297 and printer 2296, which may be connected through an output peripheral interface 2295.

The computer 2210 may operate in a networked environment using logical connections to one or more remote computers, such as a remote computer 2280. The remote computer 2280 may be a personal computer, a server, a router, a network PC, a peer device or other common network node, and typically includes many or all of the elements described above relative to the computer 2210, although only a memory storage device 2281 has been illustrated. The logical connections depicted include a local area network (LAN) 2271 and a wide area network (WAN) 2273, but may also include other networks. Such networking environments are commonplace in offices, enterprise-wide computer networks, intranets and the Internet.

When used in a LAN networking environment, the computer 2210 is connected to the LAN 2271 through a network interface or adapter 2270. When used in a WAN networking environment, the computer 2210 typically includes a modem 2272 or other means for establishing communications over the WAN 2273, such as the Internet. The modem 2272, which may be internal or external, may be connected to the system bus 2221 via the user input interface 2260, or other appropriate mechanism. In a networked environment, program modules depicted relative to the computer 2210, or portions thereof, may be stored in the remote memory storage device. By way of example, and not limitation, FIG. 22 illustrates remote application programs 2285 as residing on memory device 2281. It will be appreciated that the network connections shown are exemplary and other means of establishing a communications link between the computers may be used.

The foregoing detailed description of the technology herein has been presented for purposes of illustration and description. It is not intended to be exhaustive or to limit the technology to the precise form disclosed. Many modifications and variations are possible in light of the above teaching. The described embodiments were chosen in order to best explain the principles of the technology and its practical application to thereby enable others skilled in the art to best utilize the technology in various embodiments and with various modifications as are suited to the particular use contemplated. It is intended that the scope of the technology be defined by the claims appended hereto.

We claim:

1. A computer-implemented method for restricting communications at a computer host, comprising:
determining whether a first message which is sent to a computer host meets a restriction condition, the first message intended for receipt by a first user via an application at the computer host;
if the first message meets the restriction condition, intercepting the first message before it is made accessible to the first user via the application and storing the first message so that it is inaccessible to the first user; and
responsive to receipt of an authorization, making the stored first message accessible to the first user via the application.

2. The computer-implemented method of claim 1, wherein:
the message comprises at least one of an e-mail message, instant message, chat message, and telephony message.

3. The computer-implemented method of claim 1, further comprising:
informing the first user via the application that the first message has been sent but has been made inaccessible to the first user.

4. The computer-implemented method of claim 1, further comprising:
providing an indicia via the application which enables the first user to request that an authorized user provide the authorization.

5. The computer-implemented method of claim 1, further comprising:
providing the first message as an access-restricted attachment to a second message via the application.

6. The computer-implemented method of claim 1, further comprising:
providing a user interface which allows an authorized user to access the stored first message and to enter a command for providing the authorization.

7. The computer-implemented method of claim 1, further comprising:
providing a user interface which allows an authorized user to configure the restriction condition by setting an allow or block status for contacts, the user interface including a tree view in which different nodes of the tree represent different user names of a user.

8. The computer-implemented method of claim 1, wherein the stored first message is stored in an encrypted form, the method further comprising:
decrypting the stored first message when the authorization is received.

9. The computer-implemented method of claim 1, wherein:
the first message is stored at the computer host.

10. A computer-implemented method for restricting communications at a computer host, comprising:
monitoring messages which are sent to the computer host via a network, including at least a first message which is sent by a first user, and intended for receipt by a second user, the at least a first message including a first identifier of the first user;
responsive to the monitoring of the at least a first message, determining a unique identifier with which the first identifier is associated;
determining a block or allow status based on the unique identifier; and
controlling access to the at least a first message by the second user based on the block or allow status.

11. The computer-implemented method of claim 10, wherein:
the first identifier comprises a screen name of the first user.

12. The computer-implemented method of claim 10, wherein:
the determining the unique identifier comprises accessing a data store which includes a plurality of user names which are associated with the first user, the plurality of user names being associated with the unique identifier.

13. The computer-implemented method of claim 10, wherein:
the determining the unique identifier comprises accessing a data store which includes a plurality of user names and associated unique identifiers which are associated with different service providers.

14. Computer readable media having computer readable code embodied thereon for programming at least one processor to perform a method for notifying a user of monitoring at a computer host, the method comprising:
monitoring messages which are received by a first user at the computer host via a network, the first user using a first communications application to received the messages, the messages including at least a first message which is sent by at least a second user, the second user using a second communications application to send the at least a first messages; and
notifying the second user of the monitoring via the second communications application.

15. The computer readable media of claim 14, wherein:
the notifying of the second user comprises modifying at least a second message which is generated by the first user via the first communications application to include a notification.

16. The computer readable media of claim 14, wherein:
the notifying of the second user comprises generating a message with a notification, and providing the message with the notification to the second user via the second communications application.

17. The computer readable media of claim 14, wherein the method further comprises:
notifying the first user of the monitoring via the first communications application.

18. The computer readable media of claim 17, wherein:
the notifying of the first user comprises generating a message with a notification, and providing the message with the notification to the first user via the first communications application.

19. The computer readable media of claim 17, wherein:
the notifying of the first user comprises modifying the at least a first message to include a notification.

20. The computer readable media of claim 14, wherein the method further comprises:
monitoring messages which are sent by the first user via the first communications application, including at least a second message which is sent to the at least a second user; and
notifying the second user, via the second communications application, of the monitoring, responsive to the sending of the at least a second message.
